(19) United States
(12) Patent Application Publication
(10) Pub. No.: US 2013/0282353 A1
(43) Pub. Date: Oct. 24, 2013

(54) CELL MODELING

(71) Applicant: Yannis Tsividis, New York, NY (US)

(72) Inventor: Yannis Tsividis, New York, NY (US)

(73) Assignee: SENDYNE CORP., New York, NY (US)

(21) Appl. No.: 13/515,754

(22) PCT Filed: Jun. 11, 2012
(86) PCT No.: PCT/US12/41948

§ 371 Date: Jun. 13, 2012

Related U.S. Application Data
(60) Provisional application No. 61/495,986, filed on Jun. 11, 2011.

(51) Int. Cl. G06F 17/50

(52) U.S. Cl. CPC G06F 17/5036
USPC 703/18

(57) ABSTRACT

An arrangement provides simulation of important battery factors such as state of charge or state of health, and the estimates are provided to the human user in ways that permit the human user to make better use of the battery, for example in an electric car. The arrangement uses modeling elements that communicate with each other by means of an analog bus. Some lines on the analog bus are voltages that are intended to be inputs to the simulation or actual measured values from a physical system. Other lines, importantly, are “voltages” that are intended to communicate characteristics of interest such as open-circuit voltage of a cell. Still other lines may be “voltages” that merely pass messages between modeling elements, the voltages not necessarily representing any real-life measurable such as the afore-mentioned temperature value.

This application claims the benefit of U.S. application No. 61/495,986 filed Jun. 11, 2011, which application is incorporated herein by reference for all purposes.

### BACKGROUND

It is not easy simulating a battery. Off-the-shelf simulation tools are not as much help as one might think. One can pick some real-life parameters that one thinks may be helpful in the simulation, and the off-the-shelf simulation tool may not be able to simulate all of the parameters.

Successful simulation of a battery can permit predicting, in advance, the service life of a proposed battery in a proposed application. Thus for example there may be empirical measurements as for a particular cell that may serve as a building block for a battery that has not yet been built. It may be desired to predict the service life for the not-yet-built battery in a particular application. Or it may be desired to predict the number of charge/discharge cycles that are likely to be available from the not-yet-built battery.

In addition to simulation of a not-yet-built battery, it can be very helpful to arrive at an estimate of state of charge or state of health for an actual battery in actual service. A successful (that is, accurate) estimate of state of charge would, in an electric car, permit a successful estimate of the traveling distance available to the driver before the battery runs out. In contrast an unsuccessful estimate can lead to a very disappointed user if the battery runs out sooner than expected, thereby stranding the user. Or an unsuccessful estimate can lead to a failure to take advantage of the full capacity of the battery, for example unnecessarily forgoing a particular diversion when the diversion would, in fact, have been possible to the user.

Likewise a successful estimate of the state of health of the battery permits planning For example if the system correctly estimates that the state of health is poor, the user can arrange for a battery replacement and thus can avoid getting stranded somewhere due to battery failure. If on the other hand the system arrives at an inaccurate estimate, the user could schedule a wholly unneeded battery replacement session, wasting time and losing use of the vehicle during the trip to and from the service location. Alternatively the user could end up stranded somewhere due to a failure to estimate the (poor) state of health of the battery.

It will come as no surprise that many investigators have expended enormous amounts of time and energy attempting to develop simulation tools which might help with these real-life tasks. It will also come as no surprise that to date, no approach known to the applicant has worked out well. A successful approach would likely be “compact” as the term is used in the world of simulation, meaning among other things that it can be done with only modest computational expense while providing reasonably accurate simulation results.

### SUMMARY OF THE INVENTION

An arrangement provides simulation of important battery factors such as state of charge or state of health, and the estimates are provided to the human user in ways that permit the human user to make better use of the battery, for example in an electric car. The arrangement uses modeling elements that communicate with each other by means of an analog bus. Some lines on the analog bus are voltages that are intended to be inputs to the simulation or actual measured values from a physical system. Other lines, importantly, are “voltages” that are intended to communicate characteristics of interest such as open-circuit voltage of a cell. Still other lines may be “voltages” that merely pass messages between modeling elements, the voltages not necessarily representing any real-life measurable such as the afore-mentioned temperature value.

### DESCRIPTION OF THE DRAWING

The invention will be explained with respect to a drawing in several figures, of which:

FIG. 1 shows two modeling elements connected to an analog bus according to the invention;

FIG. 2 shows a battery module with external inputs and various test loads;

FIG. 3 shows a battery module simulated by means of modeling elements;

FIG. 4 shows a modeling element for internal resistance in a model of a cell that includes a modeled internal resistance;

FIG. 5 shows a modeling element for capacitance in a model of a cell that includes a modeled capacitance;

FIG. 6 shows a modeling element for open-circuit voltage of a cell in a model of a cell that includes a modeled open-circuit voltage;

FIG. 7 shows a modeling element for an electrochemical storage capacity of a cell in a model of a cell that includes a modeled electrochemical storage capacity;

FIG. 8 shows a modeling element for a heat generation in a cell in a model of a cell that includes a modeled heat generation;

FIG. 9 shows a model of two cells in series, each of the cells modeled by its own modeling elements such as previously discussed.

### DETAILED DESCRIPTION

One of the insights of this invention is to use a traditional electrical circuit simulator, such as Spice. The real-life parameters to be simulated are mostly voltage values at electrical lines, plus one or more physical measurables at physical locations, such as temperature. A related insight is to find ways to map the real-world values to (virtual) voltages. These “voltages” are each a proxy for a physical measurable such as temperature of something at some physical location. The information is thus passed from one simulation element to the next, as if it were a voltage being passed from one electrical line to the next.

To carry out this approach, we start by choosing key variables, on which model parameters depend (e.g., SOC, I_{LOAD}, temperature, number of cycles, age). We then represent each with a voltage: V_{SOC}, V_{ILOAD}, V_{TEMP}, V_{CYCLES}, V_{AGE}, etc. We then place them on a bus. We then connect model elements to the bus as needed.

For this to work, clearly one must devise circuits that serve to simulate the state of affairs (so far as temperature and other physical measurables is concerned) at each of several locations.

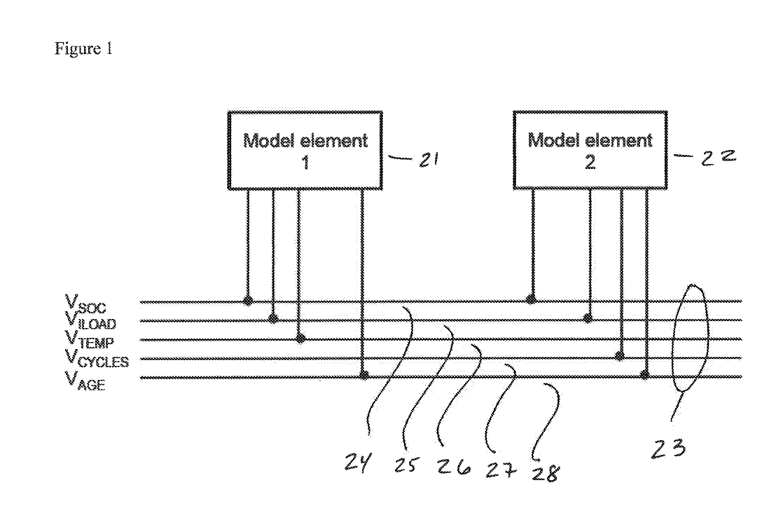

FIG. 1 shows two modeling elements connected to an analog bus according to the invention. The modeling elements 21 and 22 communicate by means of analog bus 23, which is composed of analog lines 24-28. In this example line 24 is a voltage indicative of state-of-charge of a cell, the voltage being the result of the simulation. Line 25 is the load current measured by means of a current measurement device in series with the cell. (The current measurement device is omitted for clarity in FIG. 1.) Line 26 is a voltage indicative of a simulated temperature in the cell. Line 27 is a voltage indicative of the number of charge-discharge cycles that have happened during the life of the cell. Line 28 is a voltage indicative of the age of the cell.

The reader will appreciate that these lines represent values which may be very helpful in simulation of the state of the cell, but that other values may likewise prove helpful in such simulation. The invention should not be understood as limited to the particular values shown in the analog bus 23 of FIG. 1.

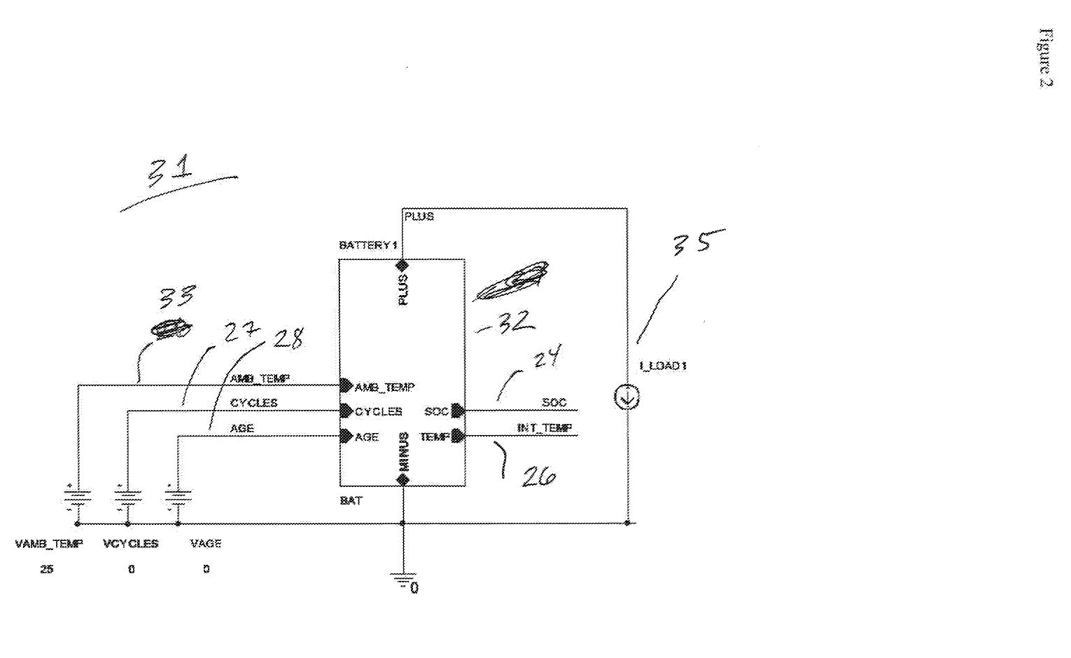

FIG. 2 shows a battery simulation module 32 with external inputs and various test loads. Inputs to the simulation module include the number-of-cycles value at 27 and the age value at 28. The simulated (estimated) state-of-charge value is at 24. Test load 35 is provided for purposes of the simulation.

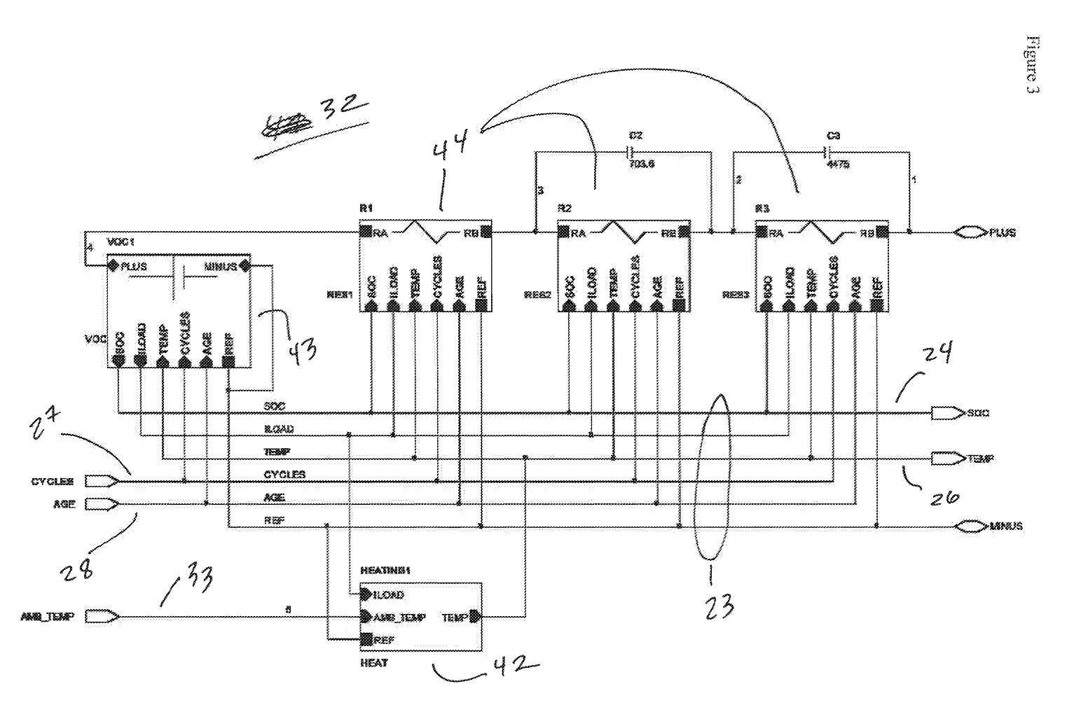

FIG. 3 shows the battery module 32 in greater detail, simulated by means of modeling elements. Inputs to module 32 include the previously mentioned age and cycles values, and outputs include the state-of-charge value. Within the simulated battery module 32 are exemplary modeling elements such as element 42, which models temperature (heat generation) within a cell, element 43 which models the open-circuit voltage of the cell, and elements 44 which model resistive elements in the model of the cell. These various modeling elements communicate with each other by means of the analog bus 23.

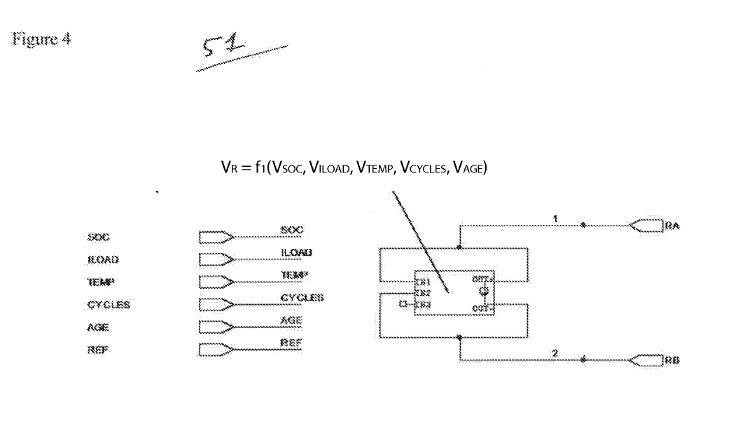

FIG. 4 shows a modeling element for internal resistance in a model of a cell that includes a modeled internal resistance.

It should be appreciated by the reader that although a particular functional relationship is set forth in FIG. 4, based upon a guess as to the dependence of cell internal resistance upon the number of cycles and upon the state-of-charge, the invention is not to be understood as limited to this particular functional relationship. Thus for example the functional relationship that might turn out to yield better results might take more or fewer inputs or different inputs. Finally, the some other selection or arrangement of modeling elements could well turn out to model some cell more accurately than the selection or arrangement of modeling elements depicted herein.

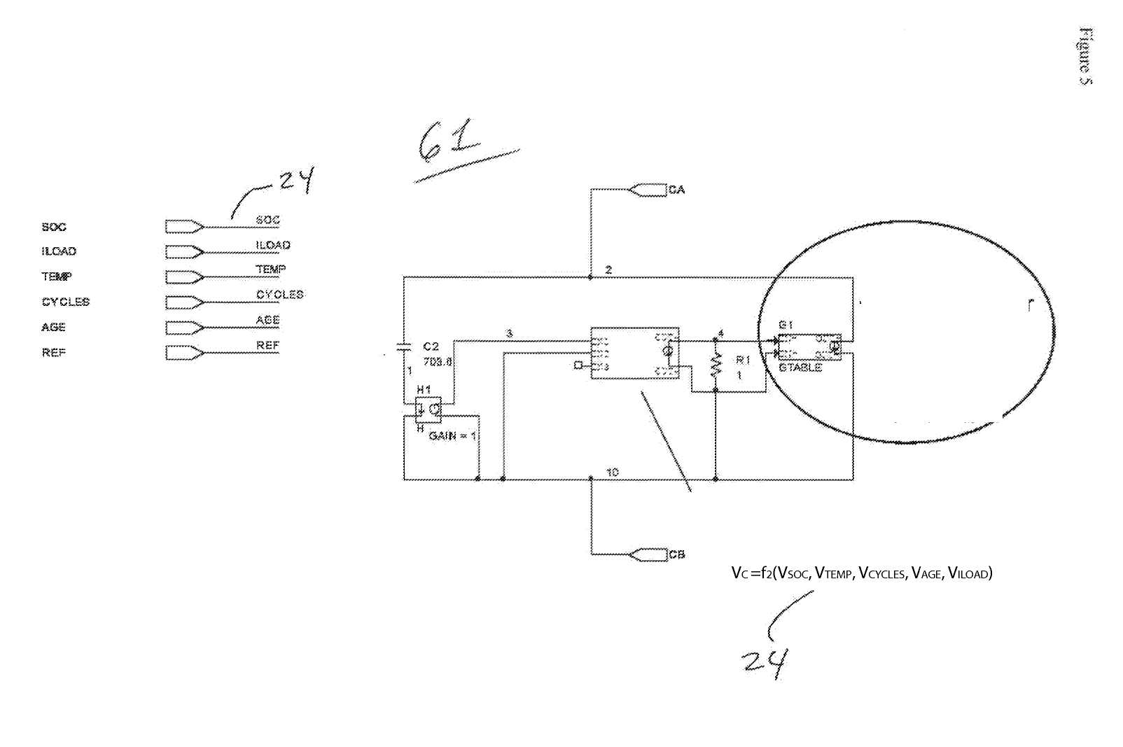

FIG. 5 shows a modeling element 61 for capacitance in a model of a cell that includes a modeled capacitance. The element 61 takes as input (among other things the signal from the analog bus called SOC which is line 24.

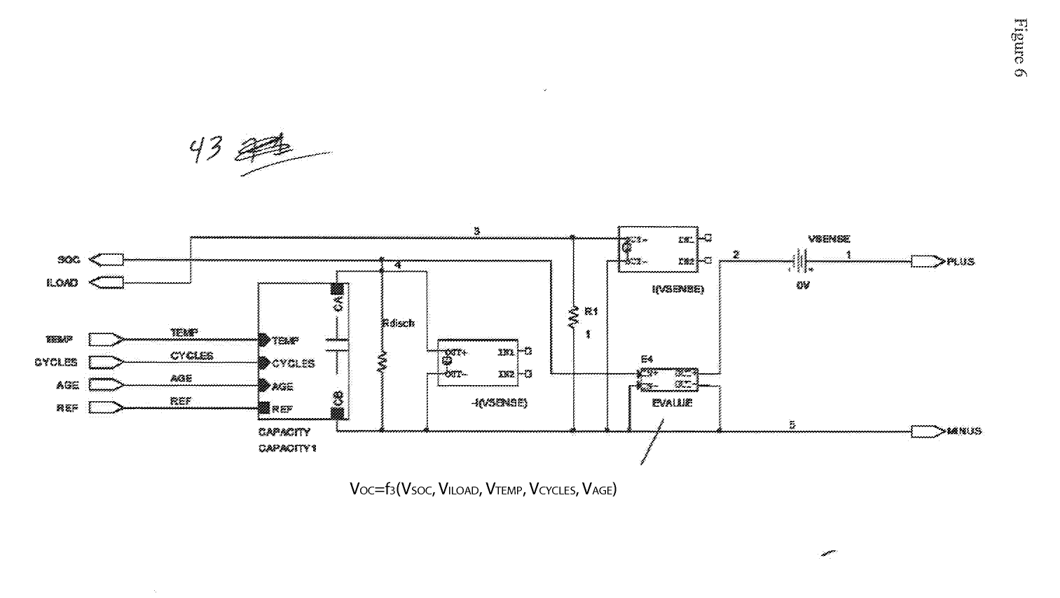

FIG. 6 shows a modeling element 43 for open-circuit voltage of a cell in a model (FIG. 3) of a cell that includes a modeled open-circuit voltage. Again a particular functional relationship is assumed for a particular cell being modeled, but some other relationship may turn out in particular cases to offer better results.

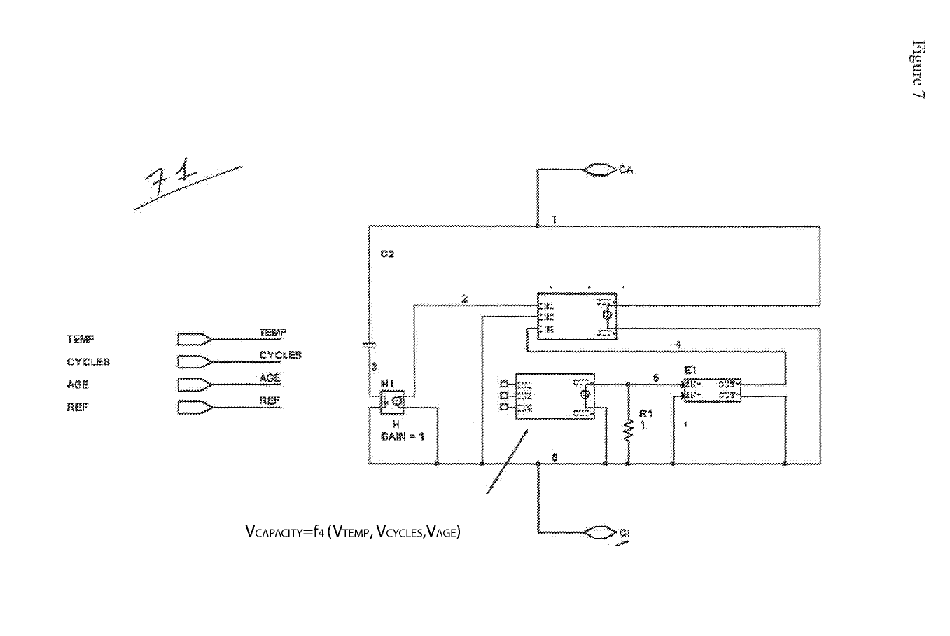

FIG. 7 shows a modeling element 71 for an electrochemical storage capacity of a cell in a model of a cell that includes a modeled electrochemical storage capacity.

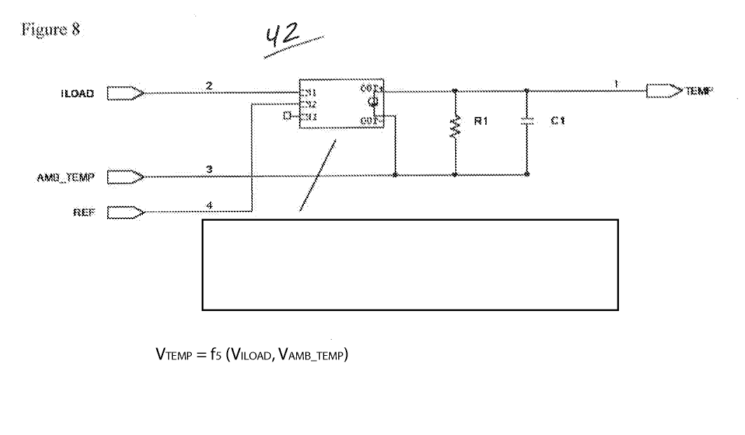

FIG. 8 shows a modeling element 42 for a heat generation in a cell in a model of a cell that includes a modeled heat generation.

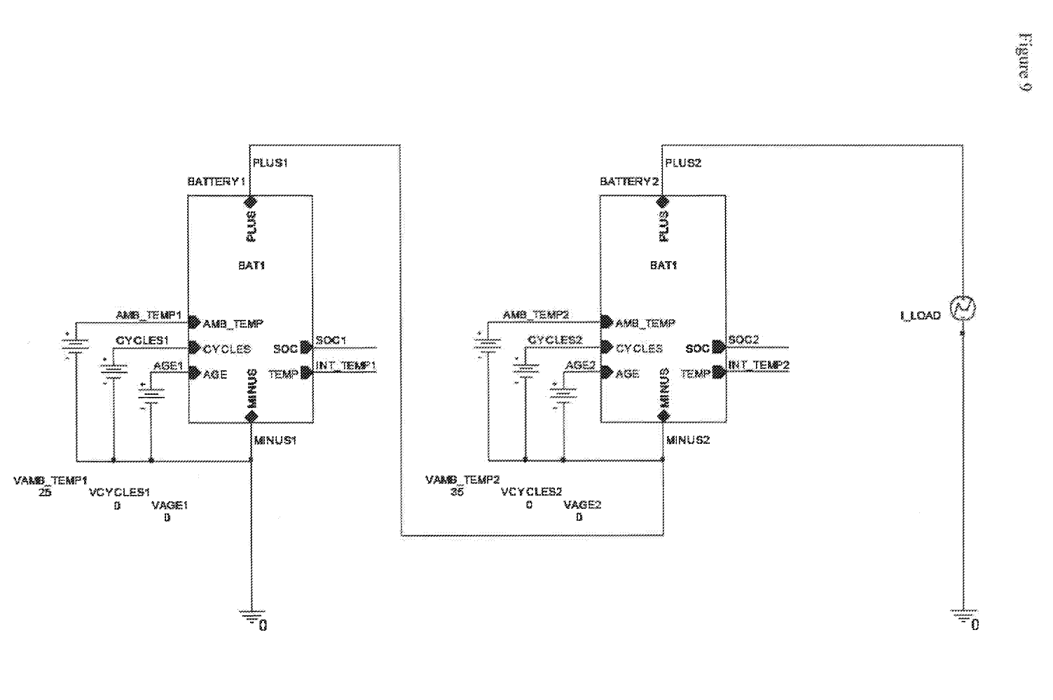

FIG. 9 shows a model of two cells in series, each of the cells modeled by its own modeling elements such as previously discussed. It will be appreciated that each (modeled) cell has its own analog bus with voltages representing such things as age of the cell, number of cycles for the cell, the (modeled) temperature of the cell, and the (modeled) state-of-charge of the cell.

Advantages of the bus approach described here include the ability to adding new dependency variables as desired; this is done by simply adding a line to the bus. The bus approach also permits adding another dependency to a given element; one simply connects the element to the corresponding bus line. Such a change does not increase the number of lines. The bus approach is thus modular and is battery-type-independent.

In this modeling approach, modules can have:
main terminals for connection to the rest of the model;
inputs, for receiving information on the variables that affect them;
outputs, for providing information on their internal conditions.

It is better not to use grounds within modules, as these can interfere with each other when the modules are combined.

One disclosed embodiment is a software circuit simulator such as Spice or Pspice, in which each of the modeling elements is modeled by the software circuit simulator. But another embodiment uses actual physical circuits, the circuits connected by means of the analog bus. Still another approach is a hybrid approach, with some modeling elements modeled by the software circuit simulator and others provided as actual circuits. Through any of these approaches, one of the insights is the use of an analog bus having some lines representing real-world voltages, other lines representing physical parameters (such as temperature) being modeled, and still other lines perhaps representing “hidden variables”, namely values passed between modeling elements that are not known to the system designer to represent physical measurables but that nonetheless contribute to a better simulation and thus a better estimate of the real-world state being estimated.

The approach of the invention arrives at an estimate of a state of a battery having at least first and second electrical terminals, and communicates the estimate to a human user. The battery has at least a current measurement device in series therewith. The battery has at least a first temperature sensor. An analog bus is defined within the inventive system as discussed above. Each modeling element connects to at least two lines of the analog bus. For any one line of the analog bus, at most only one of the modeling elements will drive the line with a low-impedance driver; the remaining modeling elements merely sense the voltage on the line with high-impedance sensing connections. Other lines could be added by which modeling elements communicate in some other way, for example a pullup resistor and a number of open-collector “pull-down” transistors to ground, for passing high-low signals.

The typical battery states to be estimated may include state-of-charge or state-of-health but may also include other states or other measurables.

Those skilled in the art will have no difficulty devising myriad obvious variants and improvements upon the invention, all of which are intended to be encompassed within the claims which follow.

1-4. (canceled)

5. A method of arriving at an estimate of a state of a battery having at least first and second electrical terminals, and communicating said estimate to a human user, the battery having at least a current measurement device in series therewith, and having at least a first temperature sensor, the method comprising the steps of:
defining at least one first line in a circuit simulator, each of the at least one first lines indicative of a physical measurable value at a real-world location;
defining a plurality of second lines in the circuit simulator, each of the second lines indicative by means of a virtual voltage of a parameter at a real-world respective physical location being simulated, and at least one of the plurality of second lines defined as indicative of the state of the battery being estimated;
the at least one first line and the plurality of second lines defining an analog bus within the circuit simulator providing at least first and second modeling elements in the circuit simulator, each of the modeling elements connected within the circuit simulator to at least one of the lines among the at least one first line and the plurality of second lines,
carrying out a simulation within the circuit simulator as to the at least one first line and as to all of the second lines, thereby arriving at an estimate of the state of the battery; and
communicating the estimate of the state of the battery to a human user;
wherein the circuit simulator is electronic circuitry comprising circuit elements bringing about the at least first and second modeling elements, the electronic circuitry communicating the estimate of the state of the battery to the human user.

6. A method of arriving at an estimate of a state of a battery having at least first and second electrical terminals, and communicating said estimate to a human user, the battery having at least a current measurement device in series therewith, and having at least a first temperature sensor, the method comprising the steps of:
defining at least one first line in a circuit simulator, each of the at least one first lines indicative of a physical measurable value at a real-world location;
defining a plurality of second lines in the circuit simulator, each of the second lines indicative by means of a virtual voltage of a parameter at a real-world respective physical location being simulated, and at least one of the plurality of second lines defined as indicative of the state of the battery being estimated;
the at least one first line and the plurality of second lines defining an analog bus within the circuit simulator;
providing at least first and second modeling elements in the circuit simulator, each of the modeling elements connected within the circuit simulator to at least one of the lines among the at least one first line and the plurality of second lines;
carrying out a simulation within the circuit simulator as to the at least one first line and as to all of the second lines, thereby arriving at an estimate of the state of the battery; and
communicating the estimate of the state of the battery to a human user;
wherein at least a first one of the at least first and second modeling elements is electronic circuitry comprising circuit elements bringing about the at least a first one of the at least first and second modeling elements, and wherein at least a second one of the at least first and second modeling elements is simulated circuitry in a software simulator executed on a computer.

7-10. (canceled)

11. An apparatus for arriving at an estimate of a state of a battery having at least first and second electrical terminals, and for communicating said estimate to a human user, the battery having at least a current measurement device in series therewith, and having at least a first temperature sensor, the apparatus comprising:
at least one first line in a circuit simulator, each of the at least one first lines indicative of a physical measurable value at a real-world location;
a plurality of second lines in the circuit simulator, each of the second lines indicative by means of a virtual voltage of a parameter at a real-world respective physical location being simulated, and at least one of the plurality of second lines defined as indicative of the state of the battery being estimated;
the at least one first line and the plurality of second lines defining an analog bus within the circuit simulator;
at least first and second modeling elements in the circuit simulator, each of the modeling elements connected within the circuit simulator to at least one of the lines among the at least one first line and the plurality of second lines,
the apparatus further comprising a communications means for communicating the estimate of the state of the battery to a human user;
wherein the circuit simulator is electronic circuitry comprising circuit elements bringing about the at least first and second modeling elements, the electronic circuitry communicating the estimate of the state of the battery to the human user.

12. An apparatus for arriving at an estimate of a state of a battery having at least first and second electrical terminals, and for communicating said estimate to a human user, the battery having at least a current measurement device in series therewith, and having at least a first temperature sensor, the apparatus comprising:
at least one first line in a circuit simulator, each of the at least one first lines indicative of a physical measurable value at a real-world location;
a plurality of second lines in the circuit simulator, each of the second lines indicative by means of a virtual voltage of a parameter at a real-world respective physical location being simulated, and at least one of the plurality of second lines defined as indicative of the state of the battery being estimated;
the at least one first line and the plurality of second lines defining an analog bus within the circuit simulator;
at least first and second modeling elements in the circuit simulator, each of the modeling elements connected within the circuit simulator to at least one of the lines among the at least one first line and the plurality of second lines,
the apparatus further comprising a communications means for communicating the estimate of the state of the battery to a human user;
wherein at least a first one of the at least first and second modeling elements is electronic circuitry comprising circuit elements bringing about the at least a first one of the at least first and second modeling elements, and wherein at least a second one of the at least first and second modeling elements is simulated circuitry in a software simulator executed on a computer.

13-16. (canceled)

17. A method of arriving at a simulation of a battery having at least first and second electrical terminals, and communicating results of said simulation to a human user, the method comprising the steps of:
defining at least one first line in a circuit simulator, each of the at least one first lines indicative of an input to the simulation;
defining a plurality of second lines in the circuit simulator, each of the second lines indicative by means of a virtual voltage of a simulated parameter, and at least one of the plurality of second lines defined as indicative of the state of the battery being estimated;
the at least one first line and the plurality of second lines defining an analog bus within the circuit simulator;
providing at least first and second modeling elements in the circuit simulator, each of the modeling elements connected within the circuit simulator to at least one of the lines among the at least one first line and the plurality of second lines,
carrying out a simulation within the circuit simulator as to the at least one first line and as to all of the second lines, thereby arriving at an estimate of the state of the battery as a function of simulated use of the battery; and
communicating the estimate of the state of the battery to a human user;
wherein the circuit simulator is electronic circuitry comprising circuit elements bringing about the at least first and second modeling elements, the electronic circuitry communicating the estimate of the state of the battery to the human user.

18. A method of arriving at a simulation of a battery having at least first and second electrical terminals, and communicating results of said simulation to a human user, the method comprising the steps of:
defining at least one first line in a circuit simulator, each of the at least one first lines indicative of an input to the simulation;
defining a plurality of second lines in the circuit simulator, each of the second lines indicative by means of a virtual voltage of a simulated parameter, and at least one of the plurality of second lines defined as indicative of the state of the battery being estimated;
the at least one first line and the plurality of second lines defining an analog bus within the circuit simulator;
providing at least first and second modeling elements in the circuit simulator, each of the modeling elements connected within the circuit simulator to at least one of the lines among the at least one first line and the plurality of second lines,
carrying out a simulation within the circuit simulator as to the at least one first line and as to all of the second lines, thereby arriving at an estimate of the state of the battery as a function of simulated use of the battery; and
communicating the estimate of the state of the battery to a human user;
wherein at least a first one of the at least first and second modeling elements is electronic circuitry comprising circuit elements bringing about the at least a first one of the at least first and second modeling elements, and wherein at least a second one of the at least first and second modeling elements is simulated circuitry in a software simulator executed on a computer.

19-22. (canceled)

23. An apparatus for arriving at a simulation of a battery having at least first and second electrical terminals, and for communicating results of said simulation to a human user, the apparatus comprising:
at least one first line in a circuit simulator, each of the at least one first lines indicative of an input to the simulation;
a plurality of second lines in the circuit simulator, each of the second lines indicative by means of a virtual voltage of a simulated parameter, and at least one of the plurality of second lines defined as indicative of the state of the battery being estimated as a function of simulated use of the battery;
the at least one first line and the plurality of second lines defining an analog bus within the circuit simulator;
at least first and second modeling elements in the circuit simulator, each of the modeling elements connected within the circuit simulator to at least one of the lines among the at least one first line and the plurality of second lines,
the apparatus further comprising a communications means for communicating the estimate of the state of the battery to a human user;
wherein the circuit simulator is electronic circuitry comprising circuit elements bringing about the at least first and second modeling elements, the electronic circuitry communicating the estimate of the state of the battery to the human user.

24. An apparatus for arriving at a simulation of a battery having at least first and second electrical terminals, and for communicating results of said simulation to a human user, the apparatus comprising:
at least one first line in a circuit simulator, each of the at least one first lines indicative of an input to the simulation;
a plurality of second lines in the circuit simulator, each of the second lines indicative by means of a virtual voltage of a simulated parameter, and at least one of the plurality of second lines defined as indicative of the state of the battery being estimated as a function of simulated use of the battery;
the at least one first line and the plurality of second lines defining an analog bus within the circuit simulator;
at least first and second modeling elements in the circuit simulator, each of the modeling elements connected within the circuit simulator to at least one of the lines among the at least one first line and the plurality of second lines,
the apparatus further comprising a communications means for communicating the estimate of the state of the battery to a human user;
wherein at least a first one of the at least first and second modeling elements is electronic circuitry comprising circuit elements bringing about the at least a first one of the at least first and second modeling elements, and wherein at least a second one of the at least first and second modeling elements is simulated circuitry in a software simulator executed on a computer.
